(19) United States
(12) Patent Application Publication
(10) Pub. No.: US 2026/0228016 A1
(43) Pub. Date: Aug. 6, 2026

(54) SMART BOOT MANAGER

(71) Applicant: Lenovo (United States) Inc., Morrisville, NC (US)

(72) Inventors: Emerson Freitas Cardoso, Aparecidinha (BR); Cláudio Luís da Costa Pereira, Parque Morumbi - Votorantim (BR); Paulo de Tarso Vasconcelos Serra Filho, Candeias - Jaboatao dos Guararapes (BR); Rafael Martins de Sousa, Sao Paulo (BR); Joed Henrique Paes, Jales (BR); Tiago Fontoura Costa, Itu-SP (BR)

(21) Appl. No.: 19/047,279

(22) Filed: Feb. 6, 2025

(51) Int. Cl. G06F 9/4401; G06F 11/34

(52) U.S. Cl. CPC G06F 9/441; G06F 11/3476

(57) ABSTRACT

A computer implemented method includes booting a personal computer to a first operating system via an external storage device. A first script is accessed from the external storage device identifying multiple tools to execute. The first script corresponds to the first operating system. At least a first tool identified by the script is executed and a log and status of the executing is updated on the external storage device. The personal computer is then booted to a second operating system based on the log and status for execution of further tools.

### BACKGROUND

Diagnostic tools for personal computers may execute on different operating systems. It can be difficult and time consuming to run one diagnostic tool on a first operating system and then run another diagnostic tool on a second operating system that is different from the first operating system. For example, a first hardware diagnostic tool may run in UEFI format while a second hardware diagnostic tool runs in Linux. The personal computer will need to be manually rebooted into Linux from UEFI prior to executing the second hardware diagnostic tool.

While there are some tools that simplify the process of multi-booting a hardware system, such as a personal computer, the process is labor intensive.

### SUMMARY

A computer implemented method includes booting a personal computer to a first operating system via an external storage device. A first script is accessed from the external storage device identifying multiple tools to execute. The first script corresponds to the first operating system. At least a first tool identified by the script is executed and a log and status of the executing is updated on the external storage device. The personal computer is then booted to a second operating system based on the log and status for execution of further tools.

### BRIEF DESCRIPTION OF THE DRAWINGS

FIG. 1 is a block diagram illustrating a system for performing automated multi-boot process management according to an example embodiment.

FIG. 2 is a block diagram illustrating an alternative system for performing automated multi-boot process management according to an example embodiment.

FIG. 3 is a block diagram illustrating a further alternative system for performing automated multi-boot process management according to an example embodiment.

FIG. 4 is a flowchart illustrating a computer implemented method for performing automated multi-boot process management according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Existing tools simplify the process of multi-booting a hardware system, allowing users to boot different operating systems, or pre-operating system tools, from the same USB without the need to format the hardware system drive repeatedly or recreate a new bootable media.

Such tools do not allow users to specify beforehand all the tools they want to execute automatically, making the use of such tools is labor intensive, and there is a need to orchestrate the execution of different tools on different platforms (e.g., Linux®, Windows® or Pre-OS) as an execution pipeline.

An improved smart boot manager automates a multi-boot process including execution of tools supported by different platforms. The improved boot manager may also be automated to control the booting and tools execution on multiple machines connected to the same network.

Remote booting processes are described following a description of the use of a scripts that identify a sequence of tools and operating systems on which each tools should execute. The script may also identify a number of times each tool should be executed. A log is used to keep track of the sequence and status of tool execution, identifying which tools in the sequence have executed.

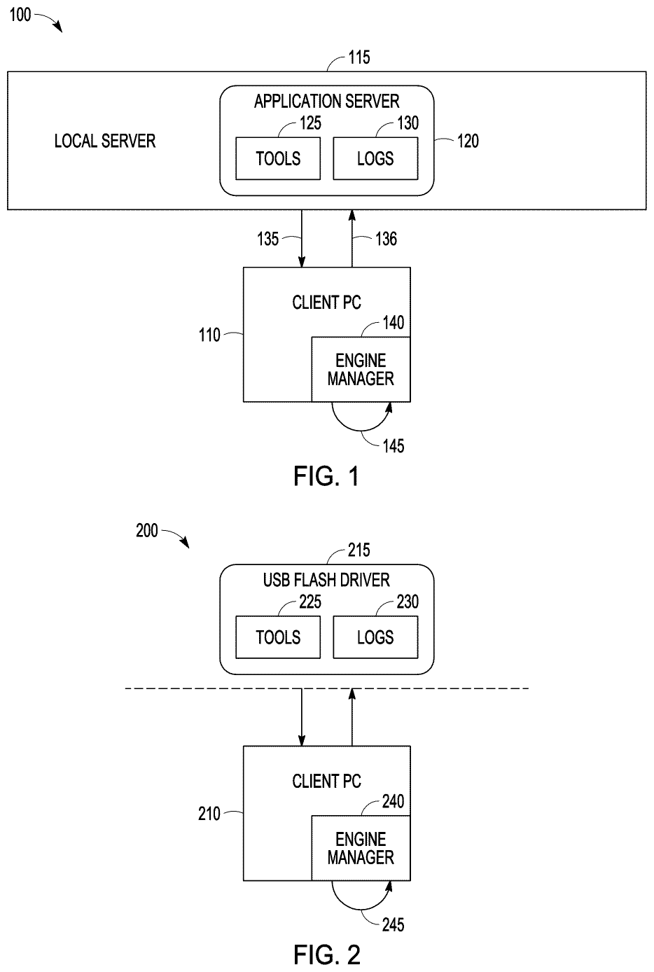

FIG. 1 is a block diagram illustrating a system 100 for performing automated multi-boot process management. A computer 110 on which diagnostic tools are to be run is shown coupled to a local server 115. Local server 115 includes an application server 120 that includes tools 125 and logs 130. The application server 120 serves as a remote storage for the tools 125 and logs 130. Automated multi-boot processing begins by connecting the computer 110 to a network illustrated as arrows 135 and 136 indicating information flow.

Upon connecting the computer 110, the computer is booted via a boot loader, such as Preboot execution environment (PXE) or Hypertext Transfer Protocol (HTTP) and a script is sent to the computer 110. The script, which is one of the tools 125, identifies a sequence of tools and operating systems on which the tools should execute. The script includes script code, which is instantiated on the computer 110 to form an engine 140. Engine 140 may also operate as a manager of the automated multi-boot process. In one example, the script code is tailored for the operating system that the computer is currently booted into. There will be different script code for each different operating system, but the sequence of tools and operating system execution will be the same for each script code.

The engine 140 will begin execution upon receiving user input, or alternatively, automatically upon completion of the boot. One or more tools in the script are then executed and the application server 120 logs 130 are updated by the engine manager with a status for each execution until a next tool is encountered that operates under a different operating system. The status may include information identifying the tools that have executed and may include information generated by the tool for use in diagnostics.

In one example, once a tool is executed, the user may be prompted to a manager generated menu to continue the next execution or view the results up to the current time. If continue is selected, a next tool may be executed or a reboot of the computer 110 into a different operating system needed by the next tool may be performed. If a different operating system is used, script code corresponding to the different operating system will be loaded from the application server 120 for instantiation as the engine 140 as indicated at 145. The log may then be checked for the status to enable the computer 110 to continue with the next tool. In one example, the entire execution sequence can be performed without user interaction.

Preboot execution environment (PXE) is a set of standards that enables a computer to load an operating system (OS) over a network connection. PXE can be used to quickly install an OS and is commonly used for both servers and client computers.

PXE can greatly simplify large deployments of computers. It replaces using a compact disc (CD) or Universal Serial Bus (USB) drive to install an OS. A single OS image can be quickly installed on many computers simultaneously.

PXE utilizes several standards for the computer and server to successfully boot. The client must support PXE in Unified Extensible Firmware Interface (UEFI) or network interface card (NIC) firmware. The network should have a configured Dynamic Host Configuration Protocol (DHCP) server and a Trivial File Transfer Protocol (TFTP) server.

The DHCP server uses options 66 and 67 to advertise the PXE boot server Internet Protocol (IP) address. The client computer then contacts the boot server and downloads and boots the Network Bootstrap Program (NBP) using TFTP. The NBP is a small OS that contains just a kernel, basic drivers and basic programs that can download the remaining OS components. Windows Preinstallation Environment or a small Linux OS are the most common operating systems loaded by a network boot.

A proxyDHCP server can be used to handle PXE requests. In one example, the client computer basic input/output system (BIOS) initiates PXE boot. This may be selected by the client computer operator or may be a fallback option when other boot media fails.

The client computer broadcasts a DHCP request and a PXE request and the DHCP server responds with the DHCP response so the client computer can set an IP address and reply with the IP address of the TFTP server and the file name of the NBP.

The client computer then downloads and boots the NBP.

Network boot is a client feature. The code to PXE is contained on the motherboard UEFI BIOS or in the NIC firmware read-only memory (ROM). It is a standard feature on enterprise computers and servers but may be omitted on some consumer hardware. On some computers, it needs to be activated in the computer's BIOS configuration.

Other computers that do not support PXE may use a similar system called Boot Server Discovery Protocol (BSDP). BSDP uses a NetBoot client to access a deployment server.

HTTP Boot is a client-server application that uses the Dynamic Host Configuration Protocol (DHCP), Domain Name System (DNS), and Hypertext Transfer Protocol (HTTP) to configure and deploy systems over a network. It's an industry standard for network booting systems that's designed to be faster and more secure than TFTP-based PXE boot. HTTP Boot works similarly to PXE boot but uses HTTP or HTTPS to download images. It can remotely install operating systems from an HTTP URL and can deploy images to servers across different subnets in routed networks. HTTP Boot can also quickly transfer larger files, such as the Linux kernel and root file system.

FIG. 2 is a block diagram illustrating a system 200 for performing automated multi-boot process management. A computer 210 on which diagnostic tools are to be run is shown coupled to a memory device 215. Memory device 215 includes tools 225 and logs 230. The memory device 215 may be a USB flash drive or memory stick and serves as a remote storage for the tools 225 and logs 230. Automated multi-boot processing begins by connecting the computer 210 to the memory device 215 and booting the computer 210 into a desired operating system.

A script is then sent to the computer 210. The script, which is one of the tools 225, identifies a sequence of tools and operating systems on which the tools should execute. The script includes script code, which is instantiated on the computer 210 to form an engine 240. Engine 240 may also operate as a manager of the automated multi-boot process. In one example, the script code is tailored for the operating system that the computer is currently booted into. There will be different script code for each different operating system as indicated at 245, but the sequence of tools and operating system execution will be the same for each script code. Operation and management of the automated multi-boot process may then occur as described above with respect to system 100.

System 200, by using memory device 215, provides for a quicker setup for a single run and requires less hardware components. It could be perceived as a simplified architecture, albeit with a certain level of complexity in its implementation. System 200 eliminates the need for a local server, as the tools and logs are stored directly on the flash drive itself.

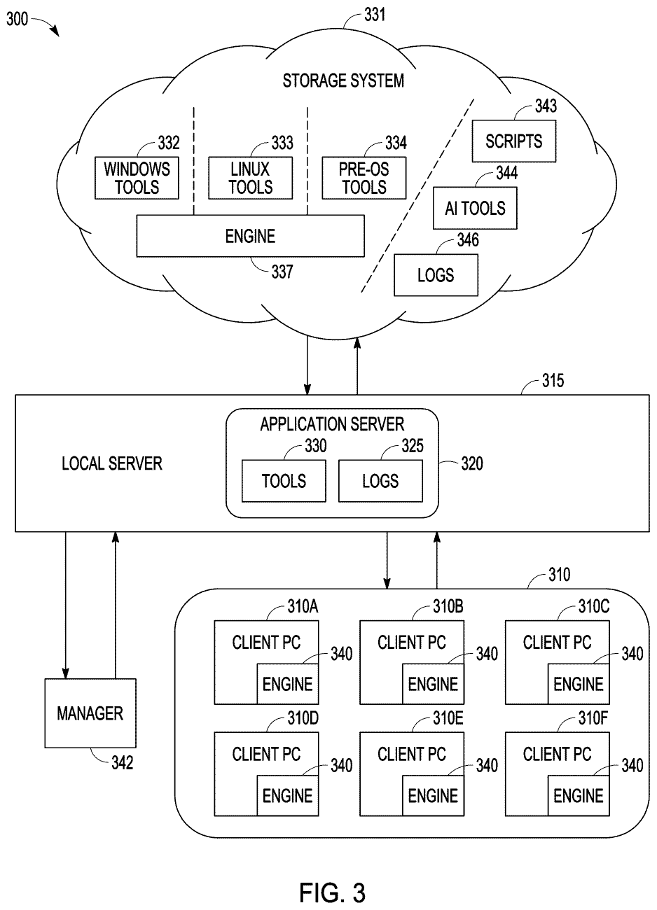

FIG. 3 is a block diagram illustrating a system 300 for performing automated multi-boot process management for multiple client computers. Multiple client computers 310 on which diagnostic tools are to be run are shown coupled to a local server 315. Local server 315 includes an application server 320 that includes tools 325 and logs 330. The application server 320 is coupled to a storage system 331 that includes tools 332, 333, and 334 for different operating systems such as Windows®, Unix® and pre-OS, and serves as a remote storage. Storage system 331 may also include a copy of the engine 337. Storage system 331 may be cloud based storage in one example or storage local to application server 320 and may also include scripts 343, AI tools 344 and logs 346. Application server 320 will access tools 332, 333, 334 from the storage system 331 based on the script and provide them to one or more of the multiple client computer 310 labeled 310A, 310B, 310C, 310D, 310E, and 310F. Such computers may have the same configuration or different configurations in various examples.

Automated multi-boot processing begins by connecting the computers 310 to a network illustrated as arrows 335 and 336 indicating information flow. Upon connecting the computer 310, one or more of the computers 310 are booted via Preboot execution environment (PXE) or Hypertext Transfer Protocol (HTTP) and a script is sent to each of the computers 310. The script may be selected based on the computer configuration and may be different for differently configured computers. The script, which is one of the tools 225, identifies a sequence of tools and operating systems on which the tools should execute. The script includes script code, which is instantiated on the computers 310 to form an engine 340. In one example, the script code is tailored for the operating system that the computer is currently booted into. There will be different script code for each different operating system, but the sequence of tools and operating system execution will be the same for each script code for a selected computer.

System 300 includes a separate manager 342 which may run on a separate system coupled the local server 315, such as an administrator's computer. The manager 342 is the interface through which a user will interact and receive updates about the status of the running tool. It aims to ease for the user to handle multiple computers at the same time.

The each engine 340 will begin execution upon receiving input from manager 342, or alternatively, automatically upon completion of the boot. One or more tools in the script are then executed and the application server 320 logs 330, 346 are updated by the manager 342 with a status for each execution until a next tool is encountered that operates under a different operating system. The status may include information identifying the status of the tools that have executed and may include information generated by the tool for use in diagnostics.

In one example, once a tool is executed, the user, in this case an administrator orchestrating automated boot-processing on multiple computers, may be prompted to manager 342 generated menu to continue the next execution or view the results up to the current time. If continue is selected, a next tool may be executed or a reboot of the one or more of the computers 310 into a different operating system needed by the next tool may be performed. If a different operating system is used, script code corresponding to the different operating system will be loaded from the application server 320 for instantiation as the engine 340 as indicated at 345. The log may then be checked for the status to enable the computer 310 to continue with the next tool. In one example, the entire execution sequence can be performed without user interaction.

Once execution of the script is completed, the logs may be uploaded to the storage system 331 logs 346 and can be used by AI tools 344 to provide analysis of the results. The application server 320 may perform the analysis in one example to evaluate the log information. The application server also updates the manager 342 with the status of the execution in each of the computers 310 for viewing by the administrator user.

In system 300, the manager 342 is responsible for properly selecting which OS/Tool will be booted in each of the computers 310 and what will be executed, based on the previous script set by the user before the execution, and report back to the logs folder in application server.

Code for engine 340 is protocol agnostic with respect to the boot process due to the use of a boot loader and an abstraction layer in the form of libraries, for multiple boot protocols. In other words, the engine code will have different binaries for different operating systems. The respective script 343 contains the information necessary for the engine 340 to execute properly, such as the list of tools that should be executed, the number of executions that should be executed, the OS/Tool (e.g., pre-OS, Linux, or Windows) in which the tool should be executed.

The manager 342 is the interface through which the user will interact and receive updates about the status of the running tool. It aims to ease for the user to handle multiple machines at the same time.

The application server 320 is responsible for working as a gateway between the manager 342, remote storage 331, and computers 310. The application server 320 will receive the commands from the manager 342 and provide updates about each of the computers 310. Once a computer 310 is connected, the application server will provide the computer with the appropriate script code for instantiating the engine 340 and the script with the set of tools that should be executed.

Remote boot management of multiple machines on a network running different tools may be performed. Multiple different operating systems may be started, each with the purpose of running a specific tool.

The tools need not be designed to work together. In one example, random access memory (RAM) may be used and there is no need to write data to permanent ROM memory on the computers. The logs 346 may share a common region on the application server or storage where different environments (pre-OS and OS) may access the same information. Since results are stored for multiple different tool executions in different environments, the results can be unified and provided to a user.

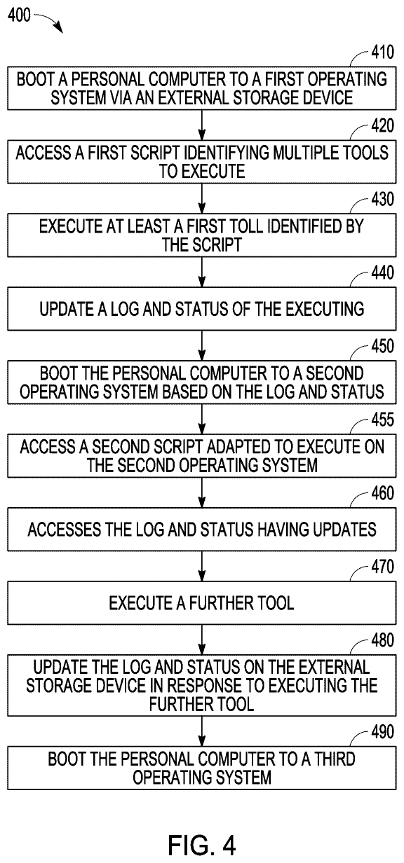

FIG. 4 is a flowchart illustrating a computer implemented method 400 of an automated multi-boot process. Method 400 begins at operation 410 by booting a personal computer to a first operating system via an external storage device. The operating system are selected from the group consisting of pre-OS, Linux, or Windows operating systems.

A first script is accessed at operation 420 from the external storage device identifying multiple tools to execute, the first script corresponding to the first operating system. The first script identifies operating systems, tools to execute under each operating system, and a number of times to execute each tool.

Operation 430 executes at least a first tool identified by the script, A log and status of the executing is updated at operation 440 on the external storage device in response to executing the at least first tool. Operation 450 boots the personal computer to a second operating system based on the log and status for execution of further tools.

Method 400 may further include in response to booting the personal computer to a second operating system for execution of further tools, accessing, from the external storage device, a second script adapted to execute on the second operating system at operation 455. The second script also identifies the multiple tools. Operation 460 accesses, from the external storage device, the log and status having updates. At least one further tool identified by the first and second scripts based on the log and status is executed at operation 470. Operation 480 updates the log and status on the external storage device in response to executing at least one further tool.

In one example, the external storage device comprises a USB drive coupled to a USB port of the personal computer. In a further example, the external storage device comprises an application server coupled via a network to the personal computer. In the case of the external storage device comprising an application server, booting a personal computer to a first operating system may be performed through PXE or HTTP.

The external storage device in one example comprises a local application server coupled via a network to the personal computer and to a storage system and a manager configured to select scripts for each of multiple personal computers.

In one example, the second operating system is booted from the local application server through PXE or HTTP.

In one example, method 400 operation 490 boots the personal computer to a third operating system for execution of further tools.

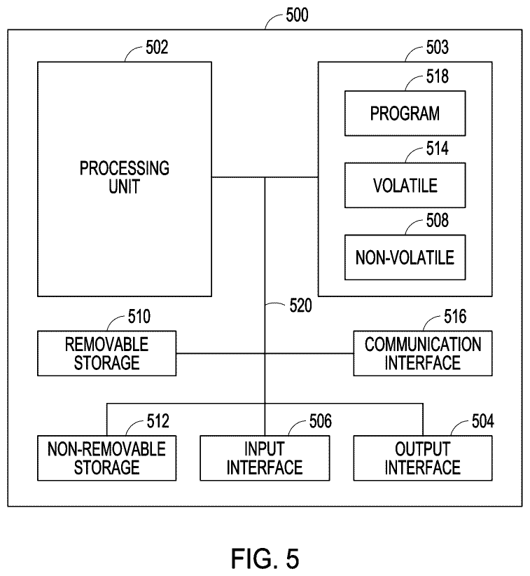

FIG. 5 is a block schematic diagram of a computer system 500 to perform automated multi-boot sequences and for performing methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 may be used to cause processing unit 502 to perform one or more methods or algorithms described herein.

### EXAMPLES

1. A computer implemented method includes booting a personal computer to a first operating system via an external storage device, accessing a first script from the external storage device identifying multiple tools to execute, the first script corresponding to the first operating system, executing at least a first tool identified by the script, updating a log and status of the executing on the external storage device in response to executing the at least first tool, and booting the personal computer to a second operating system based on the log and status for execution of further tools.
2. The method of example 1 and further including in response to booting the personal computer to a second operating system for execution of further tools, accessing, from the external storage device, a second script adapted to execute on the second operating system, the second script identifying the multiple tools, accessing, from the external storage device, the log and status having updates, executing at least one further tool identified by the first and second scripts based on the log and status.
3. The method of example 2 and further including updating the log and status on the external storage device in response to executing at least one further tool.
4. The method of any of examples 1-3 wherein the external storage device includes a USB drive coupled to a USB port of the personal computer.
5. The method of any of examples 1-4 wherein the external storage device includes an application server coupled via a network to the personal computer.
6. The method of example 5 wherein booting a personal computer to a first operating system is performed through PXE or HTTP.
7. The method of any of examples 1-6 wherein the external storage device includes a local application server coupled via a network to the personal computer and to a storage system and a manager configured to select scripts for each of multiple personal computers.
8. The method of example 7 wherein the second operating system is booted from the local application server.
9. The method of example 8 wherein the second operating system is booted through PXE or HTTP.
10. The method of any of examples 1-9 and further including executing at least a second tool identified by the script, updating a log and status in response to executing the at least second tool, and booting the personal computer to a third operating system for execution of further tools.
11. The method of any of examples 1-10 wherein the script identifies operating systems, tools to execute under each operating system, and a number of times to execute each tool.
12. The method of example 11 wherein operating systems are selected from the group consisting of pre-OS, Linux®, or Windows® operating systems.
13. A computer implemented method including booting a personal computer to a first operating system via an external storage device, receiving a script from the external storage device identifying multiple tools to execute, the script corresponding to the first operating system, executing at least a first tool identified by the script, updating a log and status in response to executing the at least first tool, and storing the log on the external storage device.
14. A computer implemented method including booting a personal computer to a first operating system via an external storage device, receiving a script from the external storage device identifying multiple tools to execute, the script corresponding to the first operating system, executing at least a first tool identified by the script, updating a log and status in response to executing the at least first tool, and storing the log on the external storage device.
15. A machine-readable storage device having instructions for execution by a processor of a machine to cause the processor to perform operations to perform any of the methods of examples 1-14.
16. A device including a processor and a memory device coupled to the processor and having a program stored thereon for execution by the processor to perform operations to perform operations to perform any of the methods of examples 1-14.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
booting a personal computer to a first operating system via an external storage device;
accessing a first script from the external storage device identifying multiple tools to execute, the first script corresponding to the first operating system;
executing at least a first tool identified by the script;
updating a log and status of the executing on the external storage device in response to executing the at least first tool; and
booting the personal computer to a second operating system based on the log and status for execution of further tools.

2. The method of claim 1 and further comprising in response to booting the personal computer to a second operating system for execution of further tools:
accessing, from the external storage device, a second script adapted to execute on the second operating system, the second script identifying the multiple tools;
accessing, from the external storage device, the log and status having updates;
executing at least one further tool identified by the first and second scripts based on the log and status.

3. The method of claim 2 and further comprising updating the log and status on the external storage device in response to executing at least one further tool.

4. The method of claim 1 wherein the external storage device comprises a USB drive coupled to a USB port of the personal computer.

5. The method of claim 1 wherein the external storage device comprises an application server coupled via a network to the personal computer.

6. The method of claim 5 wherein booting a personal computer to a first operating system is performed through PXE or HTTP.

7. The method of claim 1 wherein the external storage device comprises a local application server coupled via a network to the personal computer and to a storage system and a manager configured to select scripts for each of multiple personal computers.

8. The method of claim 7 wherein the second operating system is booted from the local application server.

9. The method of claim 8 wherein the second operating system is booted through PXE or HTTP.

10. The method of claim 1 and further comprising:
executing at least a second tool identified by the script;
updating a log and status in response to executing the at least second tool; and
booting the personal computer to a third operating system for execution of further tools.

11. The method of claim 1 wherein the script identifies operating systems, tools to execute under each operating system, and a number of times to execute each tool.

12. The method of claim 11 wherein operating systems are selected from the group consisting of pre-OS, Linux®, or Windows® operating systems.

13. A machine-readable storage device having instructions for execution by a processor of a machine to cause the processor to perform operations to perform a method, the operations comprising:
booting a personal computer to a first operating system via an external storage device;
accessing a first script from the external storage device identifying multiple tools to execute, the first script corresponding to the first operating system;
executing at least a first tool identified by the script;
updating a log and status of the executing on the external storage device in response to executing the at least first tool; and
booting the personal computer to a second operating system based on the log and status for execution of further tools.

14. The device of claim 13 wherein the operations further comprise in response to booting the personal computer to a second operating system for execution of further tools:
accessing, from the external storage device, a second script adapted to execute on the second operating system, the second script identifying the multiple tools;
accessing, from the external storage device, the log and status having updates;
executing at least one further tool identified by the first and second scripts based on the log and status.

15. The device of claim 14 wherein the operations further comprise updating the log and status on the external storage device in response to executing at least one further tool.

16. The device of claim 13 wherein the external storage device comprises a USB drive coupled to a USB port of the personal computer or an application server coupled via a network to the personal computer.

17. The device of claim 13 wherein the external storage device comprises a local application server coupled via a network to the personal computer and to a storage system and a manager configured to select scripts for each of multiple personal computers.

18. The device of claim 13 wherein the operations further comprise:
executing at least a second tool identified by the script;
updating a log and status in response to executing the at least second tool; and
booting the personal computer to a third operating system for execution of further tools.

19. The device of claim 13 wherein the script identifies operating systems, tools to execute under each operating system, and a number of times to execute each tool.

20. A device comprising:
a processor; and
a memory device coupled to the processor and having a program stored thereon for execution by the processor to perform operations comprising:
booting a personal computer to a first operating system via an external storage device;
accessing a first script from the external storage device identifying multiple tools to execute, the first script corresponding to the first operating system;
executing at least a first tool identified by the script;
updating a log and status of the executing on the external storage device in response to executing the at least first tool; and
booting the personal computer to a second operating system based on the log and status for execution of further tools.
